(19) United States
(12) Patent Application Publication
(10) Pub. No.: US 2010/0247423 A1
(43) Pub. Date: Sep. 30, 2010

(54) GOETHITE NANOTUBE AND PROCESS FOR PREPARING THEREOF

(75) Inventors: Taeghwan Hyeon, Seoul (KR); Taekyung Yu, Seoul (KR)

Correspondence Address: THE NATH LAW GROUP, 112 South West Street, Alexandria, VA, 22314, US

(73) Assignee: SEOUL NATIONAL UNIVERSITY INDUSTRY FOUNDATION, Seoul (KR)

(21) Appl. No.: 12/739,644

(22) PCT Filed: Oct. 24, 2008
(86) PCT No.: PCT/KR08/06295

§ 371 Date: May 13, 2010

(30) Foreign Application Priority Data
Oct. 25, 2007 (KR) 10-2007-0107780

(51) Int. Cl. C01G 49/02; C01G 49/06

(52) U.S. Cl. 423/633; 423/632; 977/700; 977/773; 977/840

(57) ABSTRACT

The present invention relates to a goethite nanotube. Particularly, the present invention is directed to goethite nanotubes, which can be used as a catalyst relating to environment or a drug delivery system, and process for preparing the goethite nanotube, and process for preparing magnetite and hematite nanoparticles.

### TECHNICAL FIELD

The present invention relates to a goethite nanotube. Particularly, the present invention is directed to goethite nanotubes, which can be used as an environmental catalyst or a drug delivery system, and process for preparing the goethite nanotube, and process for preparing magnetite and hematite nanoparticles.

Chemical formula of goethite is α-FeO(OH). Goethite is rarely needle-shaped, usually lump, grape-shaped, stalactitic, granular and spheroidal, and in some cases radially fibrous. Goethite is generally soft and the fracture surface of goethite is not flat. Hardness of goethite is 5.0-5.5, and goethite containing impurities is soft. Specific gravity of pure goethite is 4.28 and that of goethite containing impurities is very low. Goethite is an important iron ore and is often used as a pigment.

Chemical formula of magnetite is Fe₃O₄. The iron content of pure goethite is up to 72.41%. Magnetite is usually lump-shaped, granular and thread-shaped, and in some cases lamellar-flaky. Hardness and specific gravity of magnetite is 5.5-6.5 and 4.9-5.2, respectively. Magnetite is strongly magnetic and used as a natural magnet. When magnetite is heated under oxygen, it changes into red iron oxide (Fe₂O₃) at 220° C. and, however, its magnetic property and crystal structure do not change. At 550° C., the crystal structure of magnetite changes into hematite and thus its magnetism disappeares.

Chemical formula of hematite is α-Fe₂O₃. Pure hematite contains iron of 72.41%. Fracture surface of hematite is conchoidal or uneven. Hardness and specific gravity of hematite is 5.5-6.6 and 4.9-5.3, respectively.

The cross-sectional diameter and length of the goethite nanotube according to the present invention may be controlled by changing surfactant, iron-surfactant complex and aging temperature and time. Also, the crystal structure of magnetite and hematite nanoparticles of the present invention may be controlled by changing starting materials.

The thus-prepared goethite nanotubes and magnetite and hematite nanoparticles may be used as a catalyst for environmental processes such as adsorption of heavy metal ions. The goethite nanotubes of the present invention may be applied to medicinal application such as drug delivery system, by using their characteristics of hollowness and very small size.

### BACKGROUND ART

Various methods for producing iron oxide nanoparticles by using reverse micelle have been known, and among which representative document was repoted in Advanced Functional Materials (Youjin Lee, Jinwoo Lee, Che Jin Bae, Je-Guen Park, Han-Jin Noh, Jae-Hoon Park, and Taeghwan Hyeon, “Large-scale synthesis of uniform and crystalline magnetite nanoparticles using reverse micelles as nanoreactors under reflux conditions”). This document discloses the method for synthesizing nanoparticles in reverse micelles as nanoreactors.

U.S. patent application Ser. No. 09/920,707 discloses a method for producing micrometer-sized goethite particles by coprecipitation of iron hydrate.

In addition, Jongnam Park reported essential technique for the synthesis of the goethite nanotubes and magnetite and hematite nanoparticles of the present invention in Nature Materials in 2004 (Jongnam Park, Kwangjin An, Yosun Hwang, Je-Geun Park, Han-Jin Noh, Jae-Young Kim, Jae-Hoon Park, Nong-Moon Hwang, and Taeghwan Hyeon, “Ultra-large-scale synthesis of monodisperse nanocrystals”). This document discloses a method for producing iron-oleic acid complex on a large scale and at a low cost by using iron salt and sodium oleate.

Recently, various methods for preparing nanotubes of metal and metal oxide have been developed. However, these prior arts have the following disadvantages.

Firstly, since mean size of the nanotubes according to the prior arts is more than 50 nm, it is difficult to apply the nanotubes to fine applications such as medical application.

Secondly, the nanotubes produced by the prior arts have very low uniformity and, therefore, the methods for producing the nanotubes, according to the prior arts, are not reliable.

Thirdly, iron oxide or iron hydroxide nanotubes which are advantageous to be applied to industrial and medical applicaitons have not been reported.

Furthermore, since the amount of the nanotubes produced by the prior arts in one batch process is only several milligrams, it is not suitable to to apply the prior arts to a commercial production process.

Therefore, there remains, in the art pertaining to the production of metal and metal oxide nanoparticles, a long-felt need for a method for preparing iron oxide nanotubes and nanoparticles which have cross sections of about 10 nm through easy and inexpensive process.

### DISCLOSURE

### Technical Problem

The primary object of the present invention is to provide a goethite nanotube which may be used as an environmental catalyst and a drug delivery system.

Another object of the present invention is to provide a process for preparing goethite nanotubes in large quantity, comprising: reacting a reverse micelle mixture of organic solvent, iron-surfactant complex, surfactant and water with a reductant.

Another object of the present invention is to provide a process for preparing magnetite nanoparticles in large quantity, comprising: reacting a reverse micelle mixture of organic solvent, iron-surfactant complex, surfactant and water with a reductant.

Another object of the present invention is to provide a process for preparing hematite nanoparticles in large quantity, comprising: reacting a reverse micelle mixture of organic solvent, iron-surfactant complex, surfactant and water with an oxidant.

### TECHNICAL SOLUTION

The aforementioned primary object of the present invention can be achieved by providing a goethite nanotube. The goethite nanotube according to the present invention is a tubular nanoparticle that has a diameter and length of both from a few nanometers to hundreds of nanometers.

Another object of the present invention can be achieved by providing a process for preparing goethite nanotubes, comprising: reacting a reverse micelle mixture of organic solvent, iron-surfactant complex, surfactant and water with a reductant.

The organic solvent is selected from the group consisting of aromatic compounds such as toluene, xylene, mesitylene or benzene; heterocyclic compounds such as pyridine or tetrahydrofuran (THF); alkanes such as pentane, hexane, heptane, octane, nonane, decane, undecane, dodecane, tridecane, tetradecane, pentadecane or hexadecane, or mixtures thereof.

In addition, the iron-surfactant complex is selected from the group consisting of iron-C₁-C₁₈ carboxylic acid complex such as Fe(III)-oleate complex, F(III)-octanoate complex, Fe(III)-stearate complex, Fe(II)-oleate complex, Fe(II)-octanoate complex or Fe(II)-stearate complex, or mixtures thereof.

Furthermore, the surfactant is selected from the group consisting of C₁-C₁₈ carboxylic acid such as oleic acid, octanoic acid, stearic acid or decanoic acid; C₁-C₁₈ alkylamine such as oleylamine, octylamine, hexadecylamine, octadecylamine or tri-n-octylamine, or mixtures thereof.

In addition, the reductant is selected from the group consisting of Fe²⁺, lithium aluminum hybride (LiAlH₄), nascent hydrogen, sodium amalgam, sodium borohydride (NaBH₄), Sn²⁺, sulfite, hydrazine, zinc-mercury amalgam (Zn(Hg)), diisobutylaluminum hydride (DIBAH), Lindlar catalyst, oxalic acid or mixtures thereof.

Preferably, the reaction temperature in the process for preparing goethite nanotubes of the present invention ranges from 20° C. to 100° C. At the temperature of above 100° C., water which forms reverse micelle is evaporated and thus cannot be used as a template to produce nanoparticles. Moreover, at the temperature of below 20° C., reaction cannot proceed normally due to the solidification of starting materials.

Preferably, the reaction time in the process for preparing goethite nanotubes of the present invention ranges from 1 hour to 24 hours. When the reaction time is limited to below 1 hour, nanoparticles cannot grow to a desired size. Moreover, when the reaction time is more than 24 hours, the particle growth reaction continues, thereby deteriorating the size uniformity of the nanoparticles.

Another object of the present invention can be achieved by providing a process for preparing magnetite nanoparticles, comprising: reacting a reverse micelle mixture of organic solvent, iron-surfactant complex, surfactant and water with a reductant.

The organic solvent, iron-surfactant complex, surfactant and reductant used in the process for preparing magnetite nanoparticles of the present invention are the same as those used in the process for preparing goethite nanotubes of the present invention.

However, in order to obtain magnetite nanoparticles rather than goethite nanotubes, the reaction should be proceeded under more reductive conditions by increasing the reductant concentration in the preparation of magnetite nanoparticles more higher than that in the preparation of goethite nanotubes.

The reaction temperature and time in the process for preparing magnetite nanoparticles are the same as those in the process for preparing goethite nanotubes.

Another object of the present invention can be achieved by providing a process for preparing hematite nanoparticles, comprising: reacting a reverse micelle mixture of organic solvent, iron-surfactant complex, surfactant and water with an oxidant.

The organic solvent, iron-surfactant complex, surfactant and reaction temperature and time in the process for preparing magnetite nanoparticles of the present invention are the same as those in the process for preparing magnetite nanoparticles of the present invention.

An oxidant is used to prepare hematite nanoparticles of the present invention. The oxidant is selected from the group consisting of hypochlorite, hypobromite, hypoiodite, bromite, iodite, chlorate, bromate, iodate, perchlorate, perbromate, periodate, permanganate, chromic acid, dichromic acid, chromium trioxide, pyridinium chlorochromate (PCC), chromate, dichromate, hydrogen peroxide, Tollen's reagent, dimethylsulfoxide, diethylsulfoxide, persulfuric acid, ozone, osmium tetraoxide (OsO₄), nitric acid or nitrous oxide (N₂O), or mixtures thereof.

### ADVANTAGEOUS EFFECTS

The goethite nanotubes according to the present invention can be used as an environmental catalyst such as adsorption of heavy metals, etc. and alos a medical application such as a drug delivery system.

In addition, goethite nanotubes, magnetite nanoparticles and hematite nanoparticles can be produced in large quantity at a low cost.

### DESCRIPTION OF DRAWINGS

FIG. 1 shows TEM (transmission electron microscopy) images of the goethite nanotubes of 7 nm×80 nm in size at (a) high magnification and (b) low magnification, and (c) their arrangement.

FIG. 2 shows (a) growth process of the goethite nanotubes prepared by the process of the present invention, and TEM images of the goethite nanotubes of (b) 7 nm×150 nm and (c) 7 nm×150 nm in size.

FIG. 3 shows TEM images of the goethite nanotubes, viewed from different angles, prepared by the process of the present invention.

FIG. 4 shows an XRD (X-ray diffraction) pattern of the goethite nanotubes prepared by the process of the present invention.

FIG. 5 shows a magnetic property of the goethite nanotubes prepared by the process of the present invention, measured by SQUID (superconduction quantum interference device).

FIG. 6 shows DLS (dynamic light scattering) data of the goethite nanotubes prepared by the process of the present invention.

FIG. 7 shows a TEM image of the goethite nanotubes prepared without water for the purpose of comparison.

FIG. 8 shows TEM images of the goethite nanotubes prepared by the process of the present invention, with the lapse of time.

FIG. 9 shows a TEM image of the goethite nanotubes of 50 nm×80 nm in size prepared by the process of the present invention.

FIG. 10 shows a TEM image of the goethite nanotubes of 12 nm×150 nm in size prepared by the process of the present invention.

FIG. 11 shows a TEM image (below) of the goethite nanotubes of 50 nm×80 nm in size prepared in large quantity of 7.2 g by the process of the present invention, and a photographic image of the dried nanotubes (above).

FIG. 12 shows TEM images of the magnetite nanoparticles of 7 nm in size prepared by the process of the present invention.

FIG. 13 shows an XRD pattern of the magnetite nanoparticles prepared by the process of the present invention.

FIG. 14 shows TEM images of the hematite nanoparticles of 7 nm in size prepared by the process of the present invention.

FIG. 15 shows an XRD pattern of the hematite nanoparticles of 7 nm in size prepared by the process of the present invention.

### BEST MODE

Hereinafter, the present invention will be described in greater detail with reference to the following examples and drawings. The examples and drawings are given only for illustration of the present invention and not to be limiting the present invention.

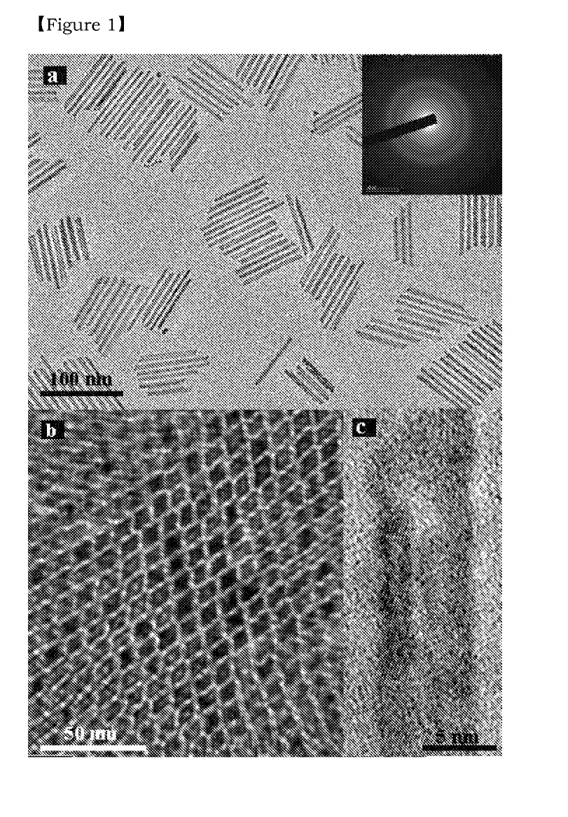

FIG. 1 shows TEM images of the goethite nanotubes of 7 nm×80 nm in size prepared by the process of the present invention. Referring to FIG. 1, the goethite nanotubes prepared by the process of the present invention have a diameter of 7 nm and a high crystallinity (FIG. 1c). In addition, it can be seen from a TEM image (FIG. 1b) that the arranged nanotubes have a parallelogrammatic cross section.

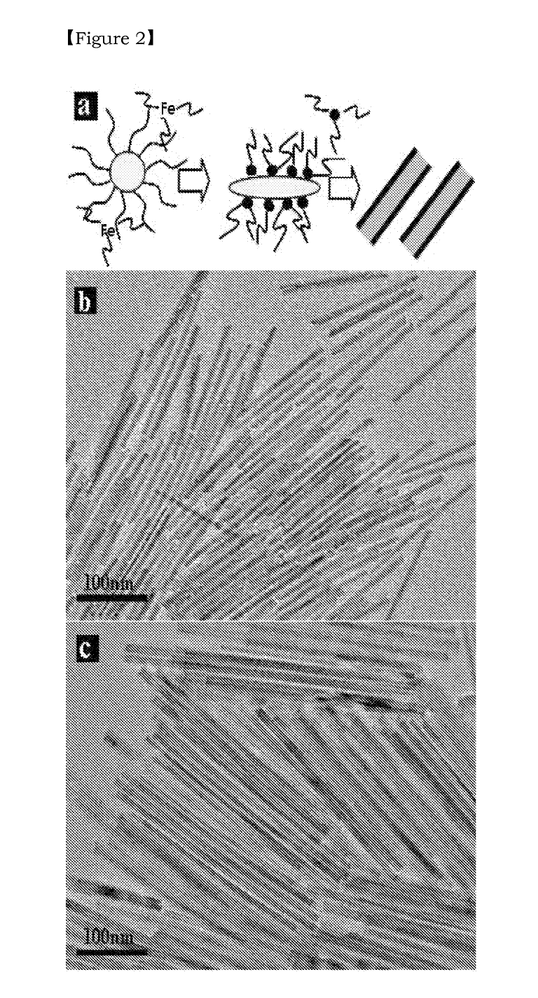

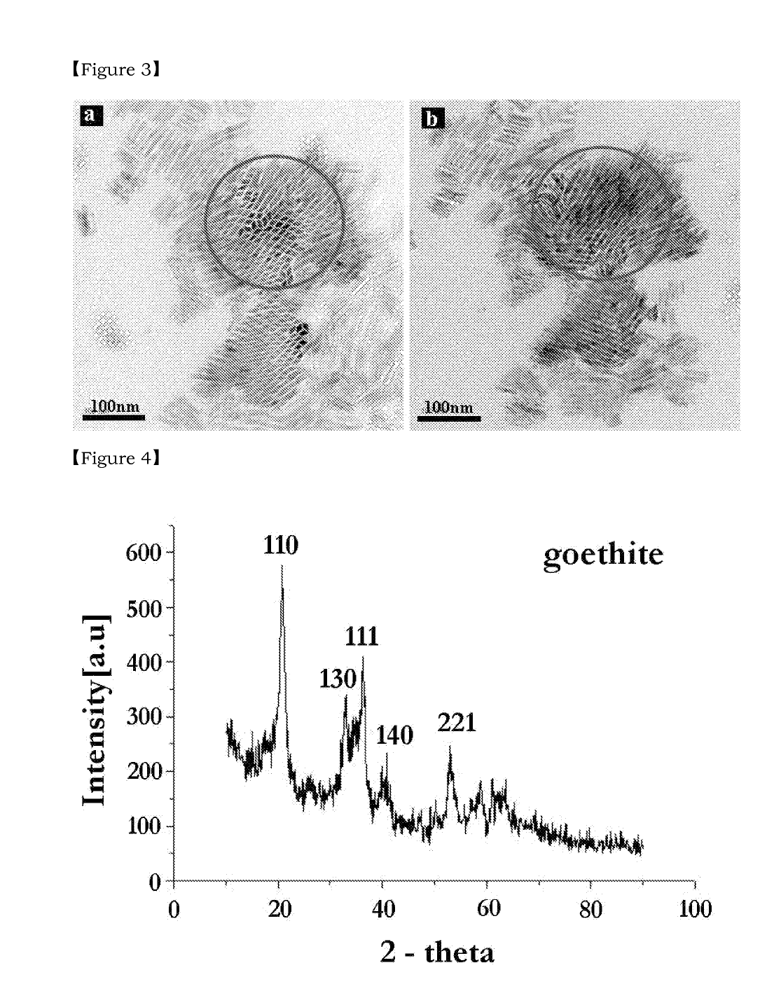

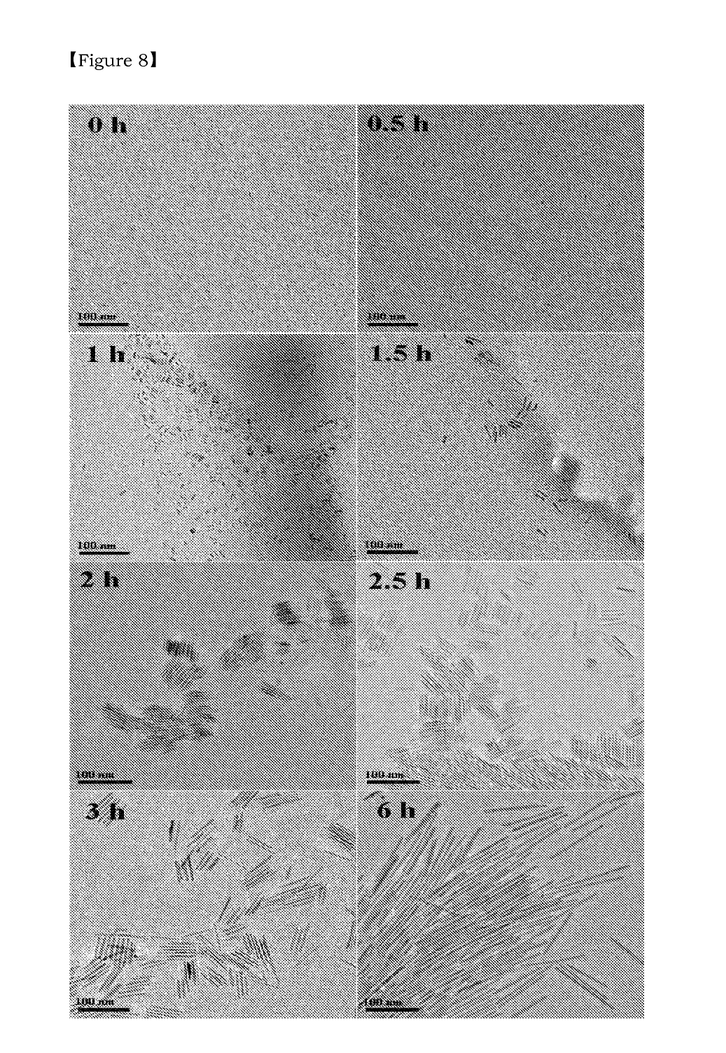

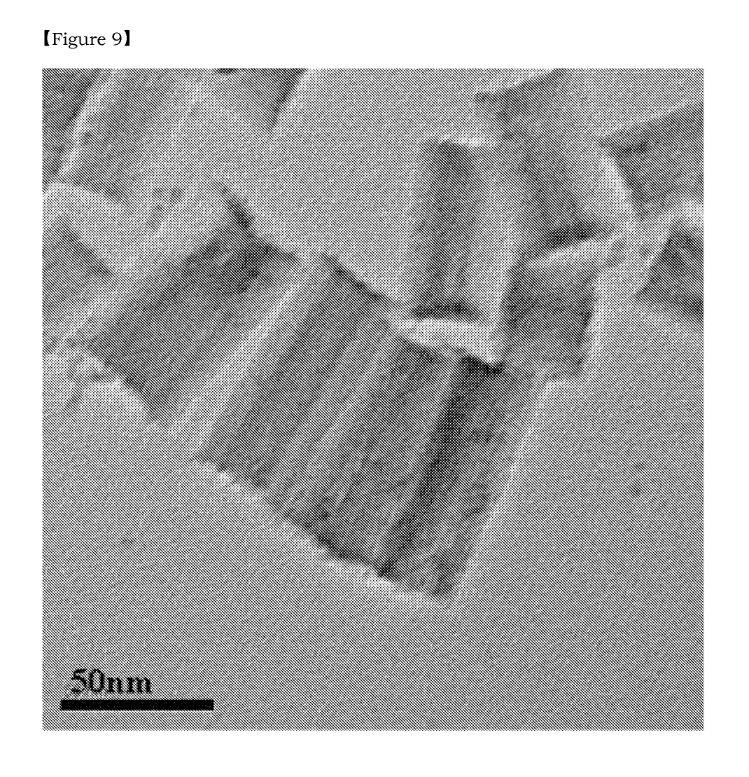

FIG. 2 shows TEM images (FIGS. 2b and 2c) of the goethite nanotubes with various lengths prepared by the process of the present invention, and the formation of the goethite nanotube (FIG. 2a). The length of the goethite nanotubes of the present invention increases with the lapse of time. This result are demonstrated by FIG. 8 which shows the growth process of the goethite nanotube.

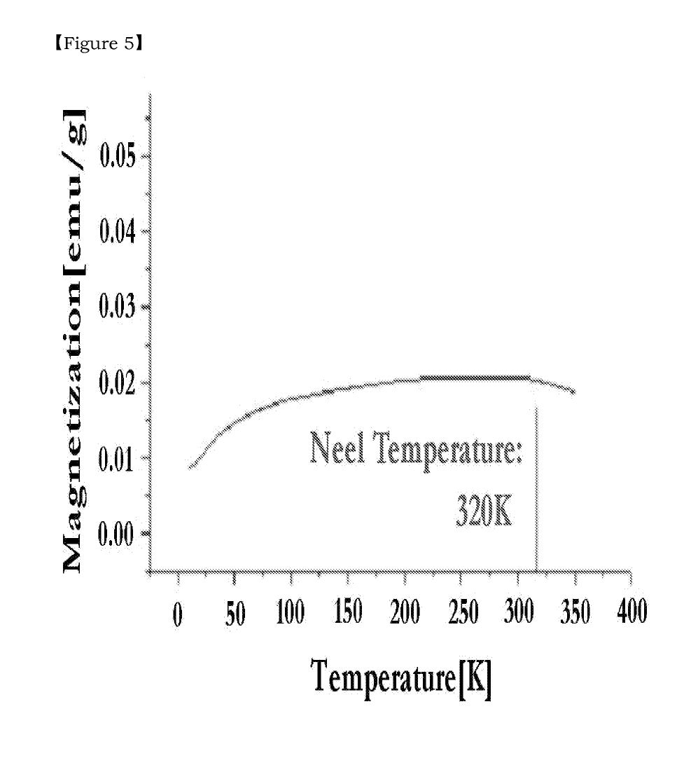

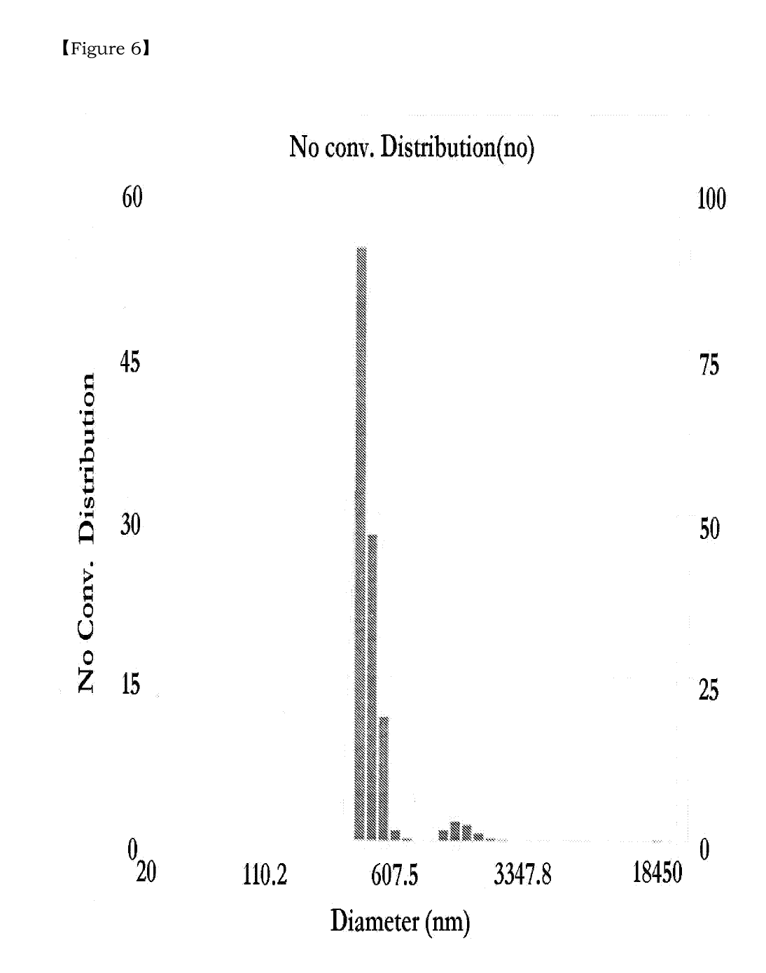

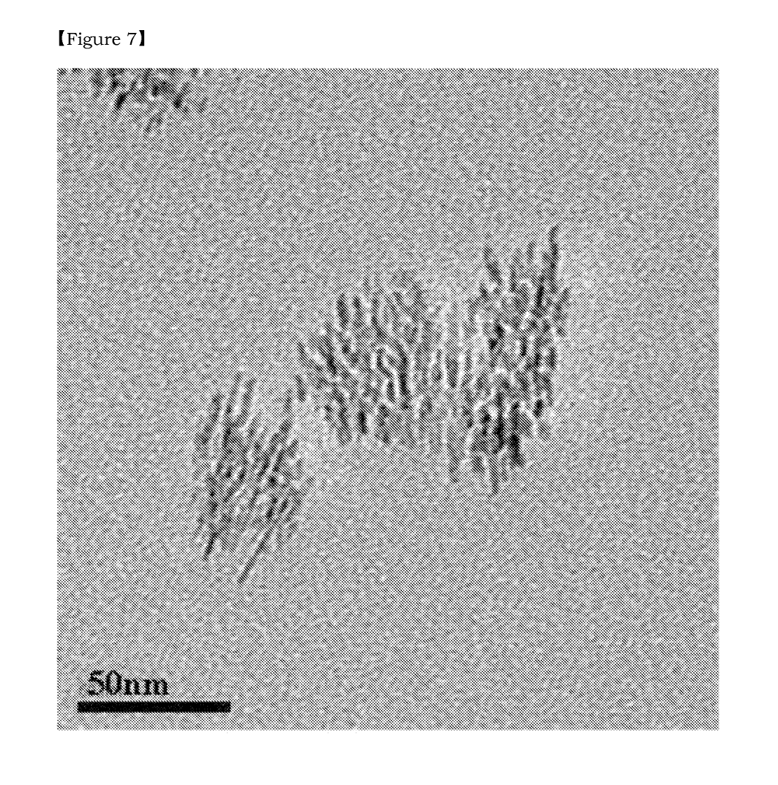

In order to investigate the crystal structure of the goethite nanotubes of the present invention, XRD was conducted and the result is shown in FIG. 4. It can be seen that the crystal structure of the goethite nanotube is monoclinic. It can be also seen that the monoclinic goethite nanotube is antiferromagnetic from SQUID analysis (FIG. 5).

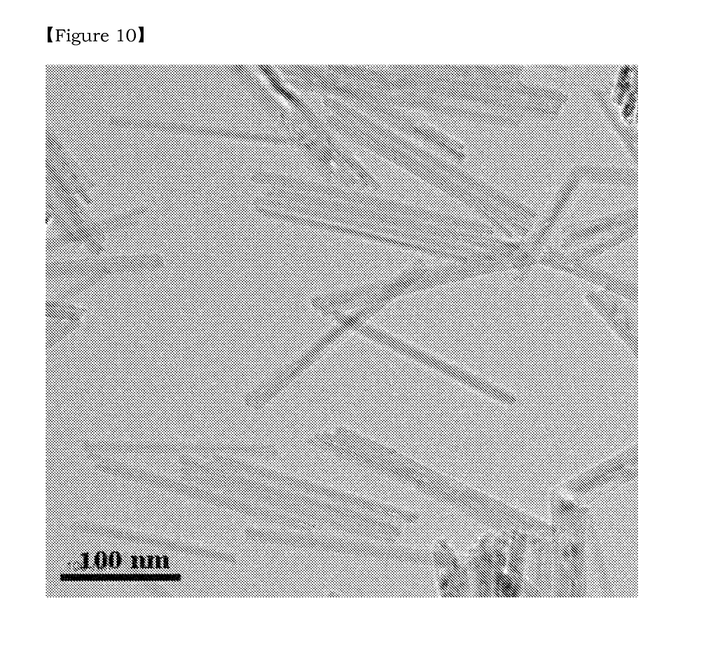

The diameter of the goethite nanotube may be controlled by varying iron-surfactant complex and surfactant. FIG. 9 shows a TEM image of 50 nm-diameter goethite nanotubes synthesized from Fe(III)-octanoate and octanoic acid, and FIG. 10 shows a TEM image of 12 nm-diameter goethite nanotubes synthesized from Fe(III)-oleate and octanoic acid.

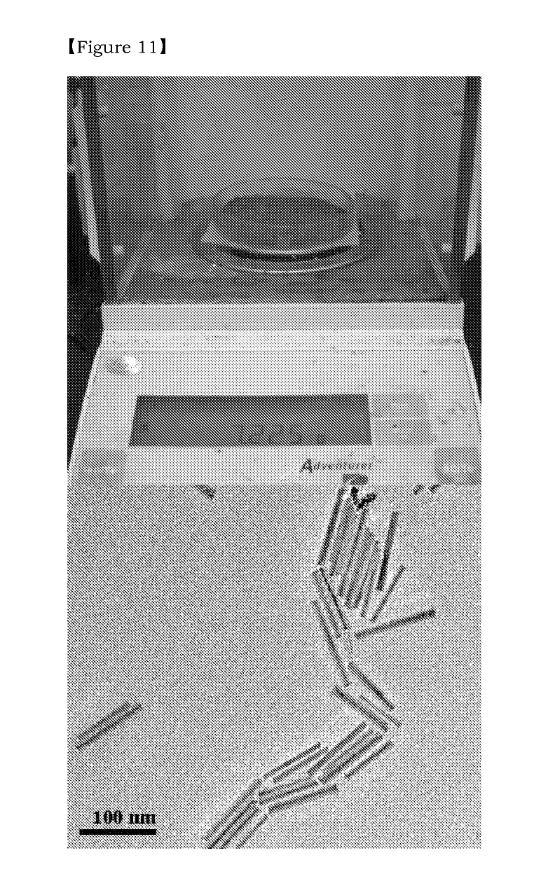

The process of the present invention is suitable for large-scale commercial production whereas the conventional process is suitable for laboratory scale. According to the present invention, up to 7.2 g of goethite nanotubes can be obtained in a single batch process by enlarging the reactor in a laboratory. FIG. 11 shows a TEM image of the goethite nanotubes prepared in the present inventors' laboratory through the enlargement of the reactor volume, and a photographic image of the dried nanotubes.

Due to the limitation in the volume of reactors used in the laboratory, 7.2 g of the goethite nanotubes were produced in a single batch and, however, this is not an inherent limitation of the present invention. Therefore, goethite nanotubes can be commercially produced in a large scale by using a commercial large reactor.

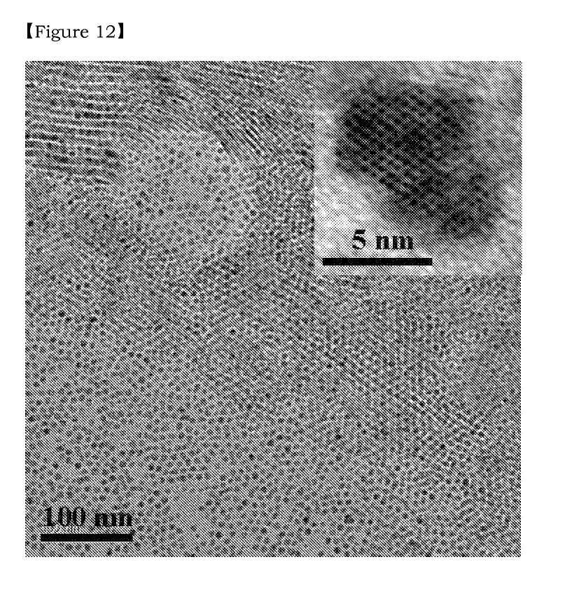

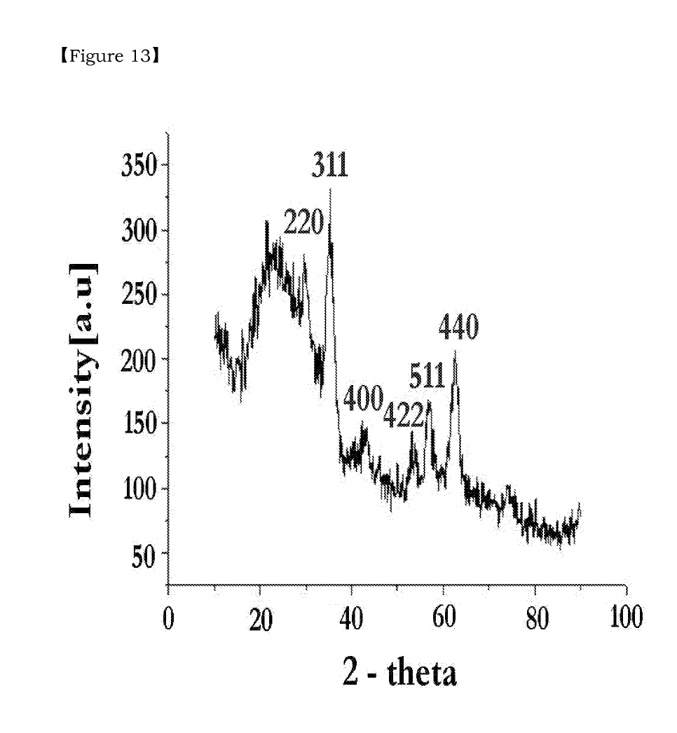

Magnetite nanoparticles can be obtained when the reaction condition becomes more reductive by the increase of the concentration of the reductant. FIG. 12 shows TEM images of the magnetite nanoparticles of 7 nm in size prepared by the process of the present invention. Referring to FIG. 12, the magnetite nanoparticles prepared by the process of the present invention have a diameter of 7 nm and a high crystallinity. FIG. 13 shows an XRD pattern of the magnetite nanoparticles prepared by the process of the present invention.

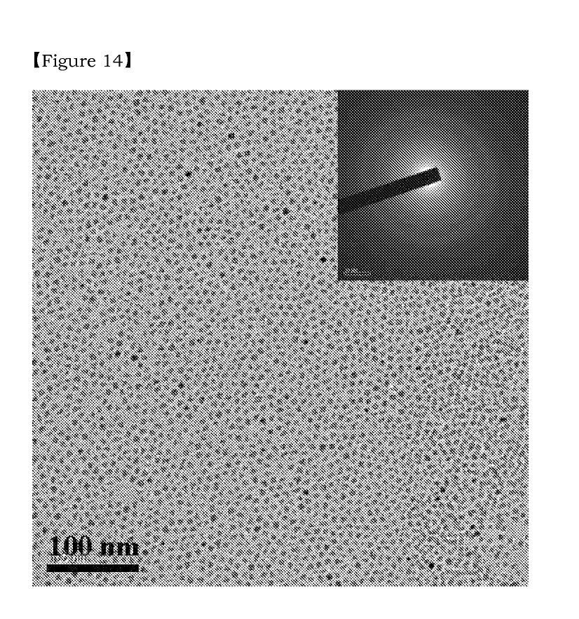

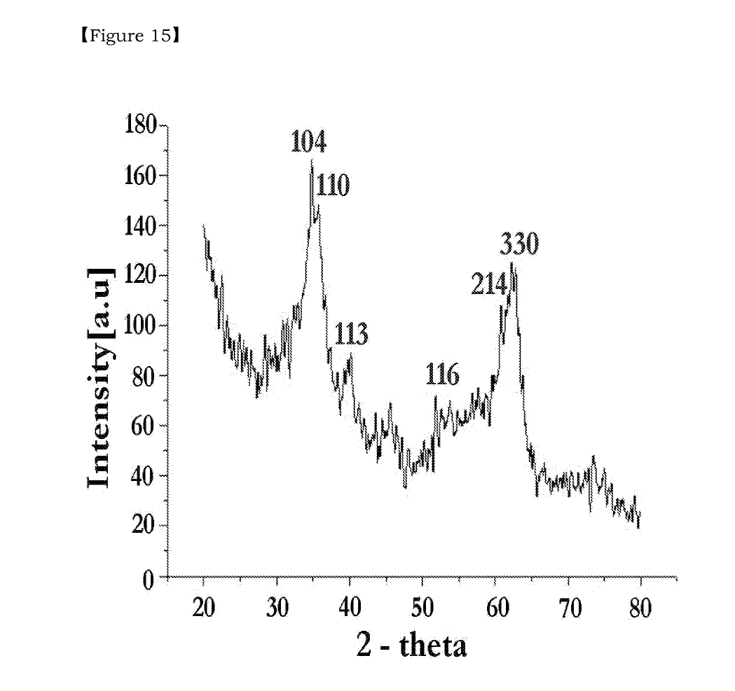

Hematite nanoparticles can be obtained by using an oxidant (e.g. hydrogen peroxide) instead of a reductant (e.g. hydrazine) in the production process. That is, the crystal structure of the nanoparticles can be transformed by changing synthetic conditions. FIG. 14 shows TEM images of the hematite nanoparticles of 7 nm in size prepared by the process of the present invention. Referring to FIG. 14, it can be seen that the hematite nanoparticles prepared by the process of the present invention have a diameter of 7 nm. FIG. 15 shows an XRD pattern of the hematite nanoparticles prepared by the process of the present invention.

### Example 1

### Synthesis of Iron-Surfactant Complex

80 ml of ethanol, 60 ml of distilled water and 140 hexane were added to 40 mmol of iron chloride hexahydrate (FeCl₃.6H₂O or FeCl₂.6H₂O) and 120 ml of sodium oleate (or sodium octanoate). The mixture was heated at 70° C. for 4 hours with being stirred. After separation of layers, the iron-surfactant complex dissolved in the upper hexane layer was separated and, then, hexane was evaporated to give gelly iron-surfactant complex.

### Example 2

### Synthesis of 7 nm×80 nm-Sized Goethite Nanotubes with a Parallelogrammatic Cross Section

4 mmol (3.6 g) of Fe(III)-oleate complex prepared in Example 1 was dissolved in 36 mmol of oleic acid and 15 ml of xylene, followed by the addition of 1 ml of distilled water and the solution was stirred for 2 hours. The solution was slowly heated to 90° C. and 3 ml of aqueous hydrazine (11%) was added to the solution, followed by the heating of the reaction mixture at 90° C. for 3 hours. The reaction mixture was cooled to room temperature and ethanol was added to the reaction mixture to induce precipitation. The precipitate was separated, washed with 50 ml of ethanol and, then, was dried.

### Example 3

### Synthesis of 7 nm×150 nm-Sized Goethite Nanotubes with a Parallelogrammatic Cross Section

4 mmol (3.6 g) of Fe(III)-oleate complex prepared in Example 1 was dissolved in 36 mmol of oleic acid and 15 ml of xylene, followed by the addition of 1 ml of distilled water and the solution was stirred for 2 hours. The solution was slowly heated to 90° C. and 3 ml of aqueous hydrazine (11%) was added to the solution, followed by the heating of the reaction mixture at 90° C. for 6 hours. The reaction mixture was cooled to room temperature and ethanol was added to the reaction mixture to induce precipitation. The precipitate was separated, washed with 50 ml of ethanol and, then, was dried.

### Example 4

### Synthesis of 7 nm×400 nm-Sized Goethite Nanotubes with a Parallelogrammatic Cross Section

4 mmol (3.6 g) of Fe(III)-oleate complex prepared in Example 1 was dissolved in 36 mmol of oleic acid and 15 ml of xylene, followed by the addition of 1 ml of distilled water and the solution was stirred for 2 hours. The solution was slowly heated to 90° C. and 3 ml of aqueous hydrazine (11%) was added to the solution, followed by the heating of the reaction mixture at 90° C. for 24 hours. The reaction mixture was cooled to room temperature and ethanol was added to the reaction mixture to induce precipitation. The precipitate was separated, washed with 50 ml of ethanol and, then, was dried.

### Example 5

### Synthesis of 50 nm×80 nm-Sized Goethite Nanotubes with a Parallelogrammatic Cross Section

4 mmol (2.0 g) of Fe(III)-octanoate complex prepared in Example 1 was dissolved in 36 mmol of octanoic acid and 15 ml of xylene, followed by the addition of 1 ml of distilled water and the solution was stirred for 2 hours. The solution was slowly heated to 90° C. and 3 ml of aqueous hydrazine (11%) was added to the solution, followed by the heating of the reaction mixture at 90° C. for 3 hours. The reaction mixture was cooled to room temperature and ethanol was added to the reaction mixture to induce precipitation. The precipitate was separated, washed with 50 ml of ethanol and, then, was dried.

### Example 6

### Synthesis of 12 nm×150 nm-Sized Goethite Nanotubes with a Parallelogrammatic Cross Section

4 mmol (3.6 g) of Fe(III)-oleate complex prepared in Example 1 was dissolved in 36 mmol of octanoic acid and 15 ml of xylene, followed by the addition of 1 ml of distilled water and the solution was stirred for 2 hours. The solution was slowly heated to 90° C. and 3 ml of aqueous hydrazine (11%) was added to the solution, followed by the heating of the reaction mixture at 90° C. for 24 hours. The reaction mixture was cooled to room temperature and ethanol was added to the reaction mixture to induce precipitation. The precipitate was separated, washed with 50 ml of ethanol and, then, was dried.

### Example 7

### Observation of the Formation 12 nm×150 nm-Sized Goethite Nanotubes with a Parallelogrammatic Cross Section with the Lapse of Time

4 mmol (3.6 g) of Fe(III)-oleate complex prepared in Example 1 was dissolved in 36 mmol of oleic acid and 15 ml of xylene, followed by the addition of 1 ml of distilled water and the solution was stirred for 2 hours. The solution was slowly heated to 90° C. and 3 ml of aqueous hydrazine (11%) was added to the solution. Then, aliquots of the solution were taken from the reaction mixture 1 min, 30 min, 1 hour, 1.5 hours, 2.5 hours, 3 hours and 6 hours after the beginning of heating the reaction mixture at 90° C., respectively. Each aliquot was cooled to room temperature and ethanol was added to each aliquot to induce precipitation. The precipitate was separated, washed with 50 ml of ethanol and, then, was dried.

### Example 8

### Synthesis of Magnetite Nanoparticles of 7 nm in Size

4 mmol (3.6 g) of Fe(III)-oleate complex prepared in Example 1 was dissolved in 15 ml of xylene, followed by the addition of 1 ml of distilled water and the solution was stirred for 2 hours. The solution was slowly heated to 90° C. and 3 ml of aqueous hydrazine (11%) was added to the solution, followed by the heating of the reaction mixture at 90° C. for 24 hours. The reaction mixture was cooled to room temperature and ethanol was added to the reaction mixture to induce precipitation. The precipitate was separated, washed with 50 ml of ethanol and, then, was dried.

### Example 9

### Synthesis of Hematite Nanoparticles of 7 nm in Size

3 mmol (1.8 g) of Fe(II)-oleate complex was dissolved in 15 ml of xylene, followed by the addition of 1 ml of distilled water and the solution was stirred for 2 hours. The solution was slowly heated to 90° C. and 1 ml of aqueous hydrogen peroxide (30%) was added to the solution, followed by the heating of the reaction mixture at 90° C. for 24 hours. The reaction mixture was cooled to room temperature and ethanol was added to the reaction mixture to induce precipitation. The precipitate was separated, washed with 50 ml of ethanol and, then, was dried.

1. A Goethite nanotube.

2. A process for preparing goethite nanotubes, comprising: reacting a reverse micelle mixture of organic solvent, iron-surfactant complex, surfactant and water with a reductant.

3. The process of claim 2, wherein said organic solvent is selected from the group consisting of toluene, xylene, mesitylene, benzene, pyridine, tetrahydrofuran, pentane, hexane, heptane, octane, nonane, decane, undecane, dodecane, tridecane, tetradecane, pentadecane, hexadecane and mixtures thereof.

4. The process of claim 2, wherein said iron-surfactant complex is selected from the group consisting of iron-C₁-C₁₈ carboxylic acid complex and mixtures thereof.

5. The process of claim 2, wherein said surfactant is selected from the group consisting of C₁-C₁₈ carboxylic acid, C₁-C₁₈ alkylamine and mixtures thereof.

6. The process of claim 2, wherein said reductant is selected from the group consisting of Fe²⁺, lithium aluminum hybride (LiAlH₄), nascent hydrogen, sodium amalgam, sodium borohydride (NaBH₄), Sn²⁺, sulfite, hydrazine, zinc-mercury amalgam (Zn(Hg)), diisobutylaluminum hydride (DIBAH), Lindlar catalyst, oxalic acid and mixtures thereof.

7. The process of claim 2, wherein said reverse micelle mixture is formed at a temperature between 20° C. and 100° C.

8. The process of claim 2, wherein said reaction is conducted at a temperature between 20° C. and 100° C.

9. The process of claim 2, wherein said reaction is conducted for 1 hour to 48 hours.

10. A process for preparing magnetite nanoparticles, comprising: reacting a reverse micelle mixture of organic solvent, iron-surfactant complex, surfactant and water with a reductant.

11. The process of claim 10, wherein said organic solvent is selected from the group consisting of toluene, xylene, mesitylene, benzene, pyridine, tetrahydrofuran, pentane, hexane, heptane, octane, nonane, decane, undecane, dodecane, tridecane, tetradecane, pentadecane, hexadecane and mixtures thereof.

12. The process of claim 10, wherein said iron-surfactant complex is selected from the group consisting of iron-C₁-C₁₈ carboxylate complex and mixtures thereof.

13. The process of claim 10, wherein said surfactant is selected from the group consisting of C₁-C₁₈ carboxylic acid, C₁-C₁₈ alkylamine and mixtures thereof.

14. The process of claim 10, wherein said reductant is selected from the group consisting of Fe²⁺, lithium aluminum hybride (LiAlH₄), nascent hydrogen, mercury amalgam (Zn(Hg)), diisobutylaluminum hydride (DIBAH), Lindlar catalyst, oxalic acid and mixtures thereof.

15. The process of claim 10, wherein said reverse micelle mixture is formed at a temperature between 20° C. and 100° C.

16. The process of claim 10, wherein said reaction is conducted at a temperature between 20° C. and 100° C.

17. The process of claim 10, wherein said reaction is conducted for 1 hour to 48 hours.

18. A process for preparing hematite nanoparticles, comprising: reacting a reverse micelle mixture of organic solvent, iron-surfactant complex, surfactant and water with an oxidant.

19. The process of claim 18, wherein said organic solvent is selected from the group consisting of toluene, xylene, mesitylene, benzene, pyridine, tetrahydrofuran, pentane, hexane, heptane, octane, nonane, decane, undecane, dodecane, tridecane, tetradecane, pentadecane, hexadecane and mixtures thereof.

20. The process of claim 18, wherein said iron-surfactant complex is selected from the group consisting of iron-C₁-C₁₈ carboxylate complex and mixtures thereof.

21. The process of claim 18, wherein said surfactant is selected from the group consisting of C₁-C₁₈ carboxylic acid, C₁-C₁₈ alkylamine and mixtures thereof.

22. The process of claim 18, wherein said oxidant is selected from the group consisting of hypochlorite, hypobromite, hypoiodite, bromite, iodite, chlorate, bromate, iodate, perchlorate, perbromate, periodate, permanganate, chromic acid, dichromic acid, chromium trioxide, pyridinium chlorochromate, chromate, dichromate, hydrogen peroxide, Tollen's reagent, dimethylsulfoxide, diethylsulfoxide, persulfuric acid, ozone, osmium tetraoxide, nitric acid, nitrous oxide and mixtures thereof.

23. The process of claim 18, wherein said reverse micelle mixture is formed at a temperature between 20° C. and 100° C.

24. The process of claim 18, wherein said reaction is conducted at a temperature between 20° C. and 100° C.

25. The process of claim 18, wherein said reaction is conducted for 1 hour to 48 hours.
